(19) United States
(12) Patent Application Publication
(10) Pub. No.: US 2013/0100260 A1
(43) Pub. Date: Apr. 25, 2013

(54) VIDEO DISPLAY APPARATUS, VIDEO PROCESSING DEVICE AND VIDEO PROCESSING METHOD

(71) Applicant: Takahiro Tanaka, Tokyo (JP)

(72) Inventor: Takahiro Tanaka, Tokyo (JP)

(73) Assignee: Kabushiki Kaisha Toshiba, Tokyo (JP)

(21) Appl. No.: 13/469,599

(22) Filed: May 11, 2012

(30) Foreign Application Priority Data
Oct. 21, 2011 (JP) 2011-231628

(51) Int. Cl. H04N 13/04

(52) U.S. Cl. 348/54; 348/E13.026

(57) ABSTRACT

According to one embodiment, a video display apparatus includes a telop detector, a correction coefficient calculator, a depth corrector, a parallax image generator, and a display. The telop detector is configured to calculate a probability of each pixel block in an input image being a telop. The correction coefficient calculator is configured to calculate a correction coefficient for a first depth value of a correction target frame so that a second depth value of a pixel block having a highest probability of being a telop out of the pixel blocks in the input image is within a first range. The depth corrector is configured to correct a third value of each pixel using the correction coefficient. The parallax image generator is configured to generate parallax images of the input image based on the corrected depth values. The display is configured to display the parallax images stereoscopically.

### CROSS REFERENCE TO RELATED APPLICATIONS

This application is based upon and claims the benefit of priority from the prior Japanese Patent Application No. 2011-231628, filed on Oct. 21, 2011, the entire contents of which are incorporated herein by reference.

### FIELD

Embodiments described herein relate generally to a video display apparatus, a video processing device and a video processing method.

### BACKGROUND

Recently, 3D displays which displays video signal stereoscopically are widely used. Some parallax images viewed from viewpoints different from each other are displayed on the 3D display. Then, by viewing one parallax image with right eye and another parallax image with left eye, the video signal can be viewed stereoscopically.

In some displays, objects at the nearest-side or at the farthest-side may be doubly-viewed. Especially, there is a problem that if characters are doubly-seen, it is so difficult to read the characters.

### BRIEF DESCRIPTION OF THE DRAWINGS

FIG. 1 is a schematic block diagram of a video display apparatus according to one embodiment.

FIG. 2 is a diagram for explaining the depth value “x”.

FIG. 3 is a flowchart showing an example of the processing operation performed by the video display apparatus.

### DETAILED DESCRIPTION

In general, according to one embodiment, a video display apparatus includes a telop detector, a correction coefficient calculator, a depth corrector, a parallax image generator, and a display. The telop detector is configured to calculate a probability of each pixel block in an input image being a telop. The correction coefficient calculator is configured to calculate a correction coefficient for a first depth value of a correction target frame so that a second depth value of a pixel block having a highest probability of being a telop out of the pixel blocks in the input image is within a first range. The depth corrector is configured to correct a third depth value of each pixel using the correction coefficient. The parallax image generator is configured to generate parallax images of the input image based on the corrected depth values. The display is configured to display the parallax images stereoscopically.

Embodiments will now be explained with reference to the accompanying drawings.

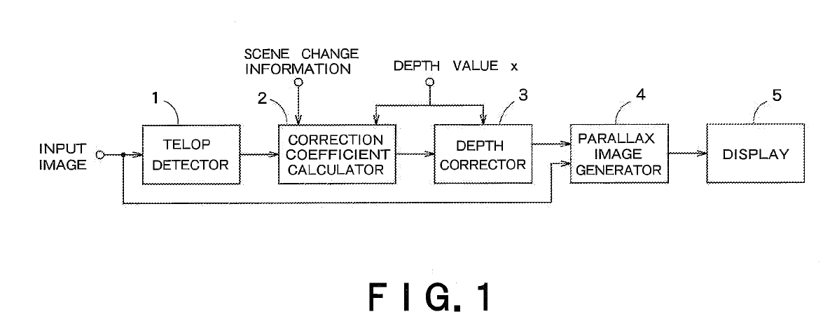

FIG. 1 is a schematic block diagram of a video display apparatus according to one embodiment. The video display apparatus has a telop detector 1, a correction coefficient calculator 2, a depth corrector 3, a parallax image generator 4, and a display 5. At least a part of the telop detector 1, the correction coefficient calculator 2, the depth corrector 3, and the parallax image generator 4 may be formed as a video processing device made of a semiconductor chip or software, for example.

The telop detector 1 calculates a probability “P” of each pixel block in an input image being a telop, and generates a probability map showing the probability of each pixel block being a telop. The correction coefficient calculator 2 calculates a correction coefficient for depth values “x” (explained later) of a correction target frame so that the depth value “x” of a pixel block having the maximum probability “p” becomes a value within a predetermined range. The depth corrector 3 corrects the depth value of each pixel using the correction coefficient to generate corrected depth values “x′”. The parallax image generator 4 generates parallax images of the input image, based on the corrected depth values “x′”. The display 5 stereoscopically displays the parallax images.

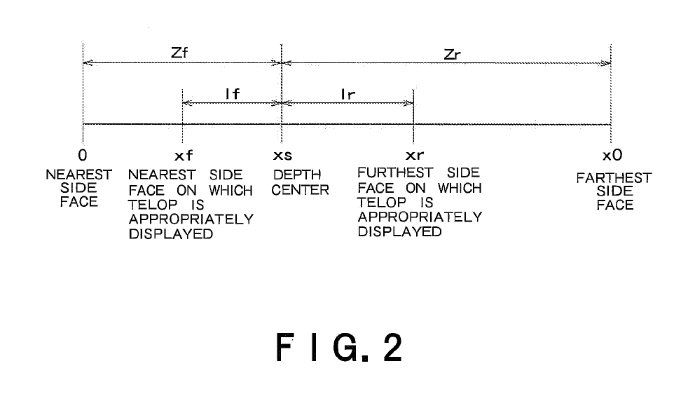

FIG. 2 is a diagram for explaining the depth value “x”. The depth value “x” may be set for each pixel block, or may be set for each pixel. In the present video display apparatus, each pixel is displayed so as to be viewed at near-side from the depth center (i.e., the position of the display 5) by “Zf” [cm] at maximum and so as to be viewed at far-side from the depth center by “Zr” [cm] at maximum. The “Zf” and the “Zr” can be adjusted by the parallax image generator 4.

The depth value “x” is a parameter indicating that the depth of each pixel is at near-side or at far-side and how far the pixel block is viewed from the display 5. In the present embodiment, “x” is a digital value within a range of “0” to “x0”. It is defined that the pixel having x=0 is displayed so as to be viewed at nearest-side (on the nearest-side face) and the pixel having x=x0 is displayed so as to be viewed farthest-side (on the farthest-side face). “x0” is 255, for example. In this case, the pixel with the depth value “x” is displayed so as to be viewed at a position apart from the nearest-side face by “Z” [cm], as expressed by the following equation (1).

Z=(Zf+Zr)*x/x0 (1)

Further, a depth value “xs” indicative of the depth center can be expressed by the following equation (2).

xs=x0*Zf/(Zf+Zr) (2)

That is, the pixel having x=xs is displayed so as to be viewed on the display 5, the pixel having x<xs is displayed so as to be viewed at near-side from the display 5, and the pixel having x>xs is displayed so as to be viewed at far-side from the display 5.

Further, the telop displayed at near-side from the depth center by “If” [cm] or less and far-side from the depth center by “Ir” [cm] or less is appropriately displayed without being viewed doubly and blurredly. In other words, in some cases, the telop may not be appropriately displayed when it is displayed at near-side from the depth center by “If” [cm] or greater, or far-side from the depth center by “Ir” [cm] or greater. The values of If and Ir can be previously known from experiment etc.

A depth value “xf” indicative of the nearest-side face on which the telop is appropriately displayed, and a depth value “xr” indicative of the farthest-side face on which the telop is appropriately displayed can be expressed by the following equations (3) and (4), respectively. Note that “Max” and “Min” are functions for returning the maximum value and minimum value of the arguments, respectively.

xf=x0*Max(0,(Zf−If)/(Zf+Zr)) (3)

xr=x0*Min(1,(Zf+Ir)/(Zf+Zr)) (4)

The depth “x” can be added to the input image in advance, or can be generated by a depth generator (not shown) based on the characteristics of the input image. For example, the depth “x” can be calculated based on the length of the motion vector. Furthermore, the structure of the whole of the input image is determined based on the characteristics such as colors or edges of the input image, and the depth “x” can be calculated by comparing the characteristics with those of pre-learned images. Additionally, human's face is detected in the input image, and the depth “x” can be calculated according to the position and/or size of the detected face applying to the predetermined template.

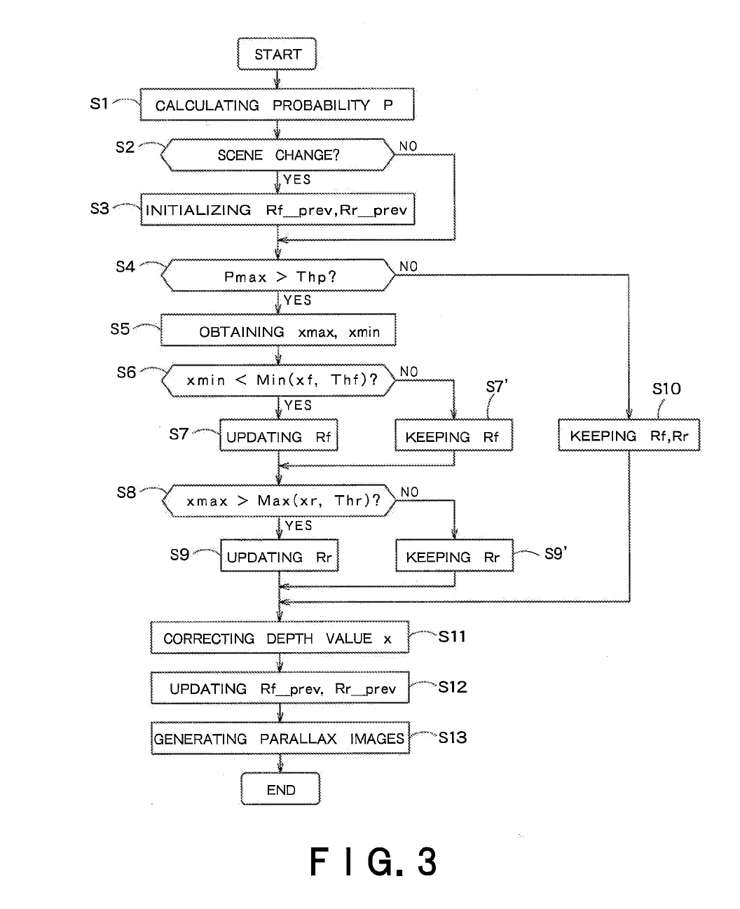

FIG. 3 is a flowchart showing an example of the processing operation performed by the video display apparatus. The operation of each module will be explained in detail using FIG. 3.

First, the telop detector 1 calculates the probability “P” of each pixel block in the input image being a telop, and generates the probability map showing the probability of each pixel block being a telop (Step S1). The probability map is stored in a memory (not shown) in the telop detector 1, as needed. The pixel block is composed of some pixels in the input image. If the number of the pixels in the pixel block is too few, accuracy of the probability “P” decreases. On the other hand, if the number of the pixels in the pixel block is too many, the processing amount of the telop detector 1 becomes large. Taking the above into account, the pixel block is, for example, composed of “16×16” pixels. Here, the telop includes captions and channel indication, and so on.

Various methods to calculate the probability “P” can be conceivable. In one of examples, coordinates where the telop is often displayed are learned in advance using a lot of sample images, and the probability “P” can be set higher as the coordinates of the center of the pixel block is closer to the learned coordinates. For example, the captions are often displayed at the lower side of the screen, and the channel indication is often displayed at upper right or upper left side of the screen. Therefore, the telop detector 1 can set the probability “P” to be higher as the pixel block locates closer to such positions.

Furthermore, the luma gradient in the pixel block which is a telop is learned using the sample images in advance, and the probability “P” can be set higher as the luma gradient in the pixel block is closer to the learned luma gradient. The luma gradient means, for example, a value obtained by accumulating absolute differences of neighboring pixel values in the pixel block.

Additionally, the telop detector 1 receives the motion vector of the pixel block from outside, and the probability “P” can be set higher as the length of the motion vector is smaller. This is because the telop is, in general, hardly moves.

Alternatively, the probability “P” can be calculated by performing character recognition. The method to calculate the probability “P” is not limited to one of the above methods, and the above methods can be combined or the probability “P” can be calculated by other method.

Next, the correction coefficient calculator 2 calculates a correction coefficient for the depth value “x” of the correction target frame so that the depth value “x” of a pixel block having the maximum probability “P” becomes a value within a predetermined range, as follows.

The correction coefficient calculator 2 judges whether or not the correction target frame is a scene change, based on scene change information indicative of presence/absence of a scene change (Step S2). If a scene change is found (YES in Step S2), correction coefficients “Rf_prev” and “Rr_prev” of the frame immediately before the correction target frame are initialized using the following equations (5) and (6), respectively (Step S3). Note that the correction coefficient “Rf_prev” is a correction coefficient for the depth value “x” to display each pixel so that it is viewed at near-side from the display 5, and the correction coefficient “Rr_prev” is a correction coefficient for the depth value “x” to display each pixel so that it is viewed at far-side from the display 5.

Rf_prev=1 (5)

Rr_prev=1 (6)

The scene change information is inputted from a scene change detector (not shown) arranged outside FIG. 1, for example. The scene change detector can generate the scene change information based on the difference between the luma histogram of the previous frame and that of the correction target frame, for example. Alternatively, the scene change detector may divide the frame into multiple areas and generate a scene change signal based on the differences between the previous frame and the correction target frame in terms of the luma signal and chroma signal of each area. Further, the above techniques may be combined, or another technique may be employed to detect the presence/absence of the scene change.

Next, the correction coefficient calculator 2 refers to the probability map generated by the telop detector 1, and compares “Pmax” which is the maximum value of the telop probability “P” with a predetermined threshold value “Thp” (Step S4). When Pmax>Thp (YES in Step S4), the correction coefficient calculator 2 acquires a maximum depth value “xmax” and a minimum depth value “xmin” with respect to each pixel block (one or more pixel blocks) having the maximum telop probability “P”. The “xmax” and the “xmin” can be obtained by referring to the depth value(s) of one or more pixels in the pixel block. Further, “xmax” and “xmin” may be obtained by using the average value or median value of the depth values of two or more pixels in the pixel block.

Then, the correction coefficient calculator 2 calculates correction coefficients “Rf” and “Rr” for the correction target frame so that the maximum value “xmax” and the minimum value “xmin” are corrected to the depth values within a range in which the telop is appropriately displayed, as follows. Note that the correction coefficient “Rf” is a correction coefficient for the depth value “x” to display each pixel so that it is viewed at near-side from the display 5, and the correction coefficient “Rr” is a correction coefficient for the depth value “x” to display each pixel so that it is viewed at far-side from the display 5. Furthermore, the correction coefficients “Rf” and “Rr” are coefficients smaller than or equal to “1” for correcting the depth value “x”.

When xmin<Min (xf, Thf) (YES in Step S6, Thf is a predetermined constant), that is, when the depth value “xmin” of the pixel displayed to be viewed at nearest-side in the correction target frame is smaller than “xf” and relatively close to the nearest side face (x=0), the correction coefficient calculator 2 updates the correction coefficient “Rf” for the correction target frame using the following equation (7) (Step S7).

$$Rf = \frac{xs - xf}{xs - x min} \qquad ( 7 )$$

As shown above, the correction coefficient “Rf” becomes smaller and correction level is increased as the depth value “xmin” becomes smaller.

On the other hand, when xmin Min (xf, Thf) (NO in Step S6), that is, when the depth value “xmin” of the pixel displayed to be viewed at nearest-side in the correction target frame is larger than “xf” or relatively close to the depth center (x=xs), there is a possibility of false telop detection even if the telop probability “P” of the pixel block is high. Therefore, the correction coefficient calculator 2 keeps the correction coefficient “Rf_prev” for the previous frame, and sets it as the correction coefficient “Rf” for the correction target frame. In other words, Rf=Rf_prev (Step S7′).

Similarly, when xmax>Max (xr, Thr) (YES in Step S8, Thr is a predetermined constant), the correction coefficient calculator 2 updates the correction coefficient “Rr” for the correction target frame using the following equation (8) (Step S9).

$$Rr = \frac{xr - xs}{x max - xs} \qquad ( 8 )$$

On the other hand, when xmax≦Max (xr, Thr) (NO in Step S8), the correction coefficient calculator 2 keeps the correction coefficient “Rr_prev” of the previous frame, and sets it as the correction coefficient “Rr” for the correction target frame. In other words, Rr=Rr_prev (Step S9′).

Further, when Pmax Thp (NO in Step S4), that is, when the maximum value “Pmax” of the telop probability is small, it is considered that there is no telop in the correction target frame. Accordingly, in this case also, the correction coefficients “Rf_prev” and “Rr_prev” are kept to be set as “Rf=Rf_prev” and “Rr=Rr_prev”, respectively (Step S10). When the correction target frame is a scene change, Rf=Rr=1 since the correction coefficients “Rf_prev” and “Rr_prev” are initialized to “1” (Step S3).

As shown in Steps S7′, S9′, and S10, when it is considered that there is no telop in the correction target frame, the correction coefficients “Rf_prev” and “Rr_prev” of the previous frame are kept. This makes it possible to prevent the correction coefficient from excessively changing according to the presence/absence of a telop between frames for the same scene.

After the correction coefficients “Rf” and “Rr” are calculated as stated above, the depth corrector 3 corrects the depth value “x” using the following equation (9) (Step S11). The “x” represents an uncorrected depth value, and the “x′” represents a corrected depth value.

x′=xs+(x−xs)*Rf if (x<xs)

x′=xs+(x−xs)*Rr else (9)

In this way, the depth value “x” of the pixel block having the maximum telop probability “P” is corrected to the value “x′” within a range satisfying xf≦x′≦xr.

The above equation (9) is applied not only on the pixel block having the maximum telop probability “P” but also all of the pixel blocks in the correction target frame to correct the depth value “x”. That is, the depth corrector 3 in the present embodiment corrects the depth value “x” of every pixel in the correction target frame using the same correction coefficient “Rf” or “Rr”. If the pixel block having higher telop probability is corrected more greatly, there is a fear that the anteroposterior relationship between pixels may be reversed. In the present embodiment, on the other hand, the depth value of each pixel in the frame is compressed toward the depth center at a constant rate, and thus the anteroposterior relationship between pixels can be kept.

After the correction process is completed, the correction coefficient calculator 2 updates the correction coefficients “Rf_prev” and “Rr_prev” using the following equations (10) and (11) in order to correct the depth value “x” of the next frame (Step S12).

Rf_{—}prev=Rf (10)

Rr_{—}prev=Rr (11)

Based on the corrected depth “x” obtained as stated above, the parallax image generator 4 generates parallax images of the input image. When the display 5 of the present embodiment is used for 3D display with glasses, the parallax image generator 4 generates two parallax images for left eye and right eye. When the display 5 is used for glassesless 3D display, for example, the parallax image generator 4 generates nine parallax images viewed from nine directions. For example, in a parallax image viewed from a left direction, the pixel block existing at near-side (that is, having small corrected depth “x”) is viewed shifted to the right side comparing to the pixel block existing at far-side (that is, having large corrected depth “x”). Therefore, based on the corrected depth “x′”, the parallax image generator 3 shifts the pixel block existing at near-side to the right side. As the corrected depth “x” is larger, the shifting amount is set larger. Then, positions where the pixel block was originally located are properly interpolated by using the surrounding pixels.

The display 5 displays the generated parallax images stereoscopically. For example, in a case of the 3D display with glasses, the parallax images for the right eye and the left eye are displayed by turns in a predetermined timing. On the other hand, in the glassless 3D display, lenticular lenses are arranged on the display 5, for example.

Then, the some parallax images are displayed at the same time, and the user views one of the parallax images with the right eye and another one of the parallax images with the left eye. In either case, the image can be seen stereoscopically by viewing different parallax images with the right eye and the left eye. Because the depth “x” is corrected as above, the pixel block existing at around the nearest-side or the farthest-side and having the high telop probability “P”, is displayed near the center of the depth.

As stated above, in the present embodiment, the depth value “x” is corrected so that the pixel block having maximum telop probability “P” is viewed on the nearest-side face or farthest-side face where the telop is appropriately displayed. As a result, the telop can be stereoscopically displayed with high quality. In addition, the anteroposterior relationship between pixels can be kept by correcting the depth value “x” using the constant correction coefficients Rf and Rr regardless of the telop probability “P” of each pixel.

At least a part of the video processing device explained in the above embodiments can be formed of hardware or software. When the video processing device is partially formed of the software, it is possible to store a program implementing at least a partial function of the video processing device in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the video processing device can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A video display apparatus comprising:
a telop detector configured to calculate a probability of each pixel block in an input image being a telop;
a correction coefficient calculator configured to calculate a correction coefficient for a first depth value of a correction target frame so that a second depth value of a pixel block having a highest probability of being a telop out of the pixel blocks in the input image is within a first range;
a depth corrector configured to correct a third depth value of each pixel using the correction coefficient;
a parallax image generator configured to generate parallax images of the input image based on the corrected depth values; and
a display configured to display the parallax images stereoscopically.

2. The apparatus of claim 1, wherein the first range is a range of depth value in which a telop is stereoscopically displayed appropriately.

3. The apparatus of claim 1, wherein the correction coefficient comprises:
a first correction coefficient for a pixel to be viewed at a side near a reference position; and
a second correction coefficient for a pixel to be viewed at a side far from the reference position.

4. The apparatus of claim 1, wherein the correction coefficient calculator is configured to use the correction coefficient for a previous frame of the correction target frame as the correction coefficient for the correction target frame, when a maximum value of the probability of the pixel block being a telop is equal to or less than a predetermined value, and when a maximum or minimum depth value of the pixel block having the maximum probability of being a telop is within a second range.

5. The apparatus of claim 4, wherein when the correction target frame is a scene change, the correction coefficient calculator is configured to initialize the correction coefficient for the previous frame of the correction target frame, and to use the initialized correction coefficient as the correction coefficient for the correction target frame.

6. A video processing device comprising:
a telop detector configured to calculate a probability of each pixel block in an input image being a telop;
a correction coefficient calculator configured to calculate a correction coefficient for a first depth value of a correction target frame so that a second depth value of a pixel block having a highest probability of being a telop out of the pixel blocks in the input image is within a first range;
a depth corrector configured to correct a third depth value of each pixel using the correction coefficient; and
a parallax image generator configured to generate parallax images of the input image based on the corrected depth values.

7. The device of claim 6, wherein the first range is a range of depth value in which a telop is stereoscopically displayed appropriately.

8. The device of claim 6, wherein the correction coefficient comprises:
a first correction coefficient for a pixel displayed so as to be viewed at a side near a reference position; and
a second correction coefficient for a pixel displayed so as to be viewed at a side far from the reference position.

9. The device of claim 6, wherein the correction coefficient calculator is configured to use the correction coefficient for a previous frame of the correction target frame as the correction coefficient for the correction target frame, when a maximum value of the probability of the pixel block being a telop is equal to or less than a predetermined value, and when a maximum or minimum depth value of the pixel block having the maximum probability of being a telop is within a second range.

10. The device of claim 9, wherein when the correction target frame is a scene change, the correction coefficient calculator is configured to initialize the correction coefficient for the previous frame of the correction target frame, and to use the initialized correction coefficient as the correction coefficient for the correction target frame.

11. A video processing method comprising:
calculating a probability of each pixel block in an input image being a telop;
calculating a correction coefficient for a first depth value of a correction target frame so that a second depth value of a pixel block having a highest probability of being a telop out of the pixel blocks in the input image is within a predetermined range;
correcting a third depth value of each pixel using the correction coefficient; and
generating parallax images of the input image based on the corrected depth values.
